(19) United States
(12) Patent Application Publication
(10) Pub. No.: US 2020/0049571 A1
(43) Pub. Date: Feb. 13, 2020

(54) TEMPERATURE SENSOR

(71) Applicant: NGK SPARK PLUG CO., LTD., Nagoya-shi (JP)

(72) Inventors: Takuma NOMURA, Nagoya-shi (JP); Seiji OYA, Nagoya-shi (JP); Toshiya OYA, Nagoya-shi (JP); Shoko KOMIYA, Nagoya-shi (JP)

(73) Assignee: NGK SPARK PLUG CO., LTD., Nagoya-shi (JP)

(21) Appl. No.: 16/532,867

(22) Filed: Aug. 6, 2019

(30) Foreign Application Priority Data
Aug. 10, 2018 (JP) 2018-151551
Apr. 17, 2019 (JP) 2019-078775

(51) Int. Cl. G01K 7/06; G01K 7/10; G01K 1/12

(52) U.S. Cl. CPC G01K 7/06; G01K 1/12; G01K 7/10

(57) ABSTRACT

A temperature sensor (1) includes: a temperature sensitive element (90); a sheath member (20) provided on a rear end side of the temperature sensitive element, and including a pair of sheath core wires (21) connected to the temperature sensitive element, and a sheath outer tube (22) accommodating the sheath core wires inside an insulation material; a pair of lead wires (80) disposed on a rear end side of the sheath member, and directly or indirectly connected to the respective sheath core wires exposed more on a rear end side than the sheath outer tube; and glass-braided insulation covering portions (25) individually covering a pair of respective connection portions (23) of the sheath core wires and the lead wires, so as to insulate between the pair of the connection potions, in a rear end from the sheath outer tube.

### BACKGROUND

The present invention relates to a temperature sensor provided with a temperature sensitive element, such as a thermistor element and a Pt-resistor element, or with a temperature measuring junction formed by joining the distal ends of a pair of thermocouple elements to each other.

As a temperature sensor for detecting temperature of, for example, exhaust gas of, for example, a vehicle, one has been known in which, for detecting the temperature, a temperature change of the resistance of a temperature sensitive element, such as a thermistor and a Pt-resistor, or a thermal electromotive force of a temperature measuring junction of a thermocouple is used. For example, as a temperature sensor using a thermistor, Japanese Patent No. 4853782 (hereinafter is referred to as “JP4853782”) discloses a temperature sensor having a structure in which a pair of core wires (sheath core wires) are connected to the rear end side of the thermistor, each of the core wires is insulated and held inside an insulation material (sheath outer tube), and a pair of lead wires are connected to the respective rear end sides of the core wires. The thermistor, the core wires including the insulation material, and the lead wires are accommodated in a metal pipe. In addition, the lead wires are pulled out to the rear end side of the temperature sensor, and are connected to a connector portion connected to an external device through a harness.

In addition, for example, Japanese Patent Application Publication No. 2002-221451 (hereinafter is referred to as “JP2002-221451”) discloses a temperature sensor having a structure in which a pair of sheath pin core wires are connected to the rear end side of a sensor portion (thermistor), and connection portions of the sheath pin core wires and lead wires are held by molded portions formed by solidifying ceramic material. Moreover, for example, Japanese Patent Application Publication No. 2014-142327 (hereinafter is referred to as “JP2014-142327”) discloses a temperature sensor having a structure in which a pair of signal lines extending from a temperature sensitive element (thermistor) toward the rear end side and a pair of lead wires connected to the signal lines are included, and connection members connecting the signal lines and the lead wires are held by a holding member made of ceramic.

### SUMMARY

However, in the temperature sensor of JP4853782, although the core wires and the respective lead wires are connected by a pair of respective connection terminals in the inside of the metal pipe, the connection terminals are exposed, and they are not insulated from each other. Consequently, if short circuit occurs between the connection terminals and between the lead wires, temperature measuring cannot be carried out, and temperature measuring accuracy deteriorates. In addition, as a method for insulating between the connection terminals, it is assumed that a tube made of heat resistant resin, such as Teflon (registered trade mark) is used. However, in a case where the temperature sensor is used under a high temperature condition, if the temperature exceeds the heat resistance temperature of the resin, the resin is carbonized, and the short circuit between the connection terminals occurs.

In addition, like the sensors of JP2002-221451 and JP2014-142327, insulation can be achieved by a molded portion or a holding member made of ceramic. However, they are heavy because they are rigid bodies, and if they are broken by impact of, for example, flying rocks, insulation properties deteriorate.

In view of the foregoing, it is desirable to provide a temperature sensor in which the connection portion of a wire from a temperature sensitive element or a temperature measuring junction and a lead wire can be surely insulated even under a high temperature condition, the connection portion which is provided inside the temperature sensor.

According to one aspect of the present invention, a temperature sensor comprises: a temperature sensitive element; a sheath member which is provided on a rear end side of the temperature sensitive element, and which includes a pair of sheath core wires connected to the temperature sensitive element, and a sheath outer tube accommodating the sheath core wires inside an insulation material; a pair of lead wires which are disposed on a rear end side of the sheath member, and which are directly or indirectly connected to the respective sheath core wires exposed more on a rear end side than the sheath outer tube; and glass-braided insulation covering portions individually covering a pair of respective connection portions of the sheath core wires and the lead wires, so as to insulate between the pair of the connection potions, in a rear end from the sheath outer tube.

According to another aspect of the present invention, a temperature sensor comprises: a pair of thermocouple wires; a temperature measuring junction formed by joining distal ends of the pair of the thermocouple wires to each other; a sheath member including at least a sheath outer tube for projecting the thermocouple wires from a distal end and a rear end thereof, while accommodating the thermocouple wires inside an insulation material; a pair of compensation conductive wires which are disposed on a rear end side of the sheath outer tube, and which are directly or indirectly connected to the respective thermocouple wires exposed more on a rear end side than the sheath outer tube; and glass-braided insulation covering portions individually covering a pair of respective connection portions of the thermocouple wires and the compensation wires, so as to insulate between the pair of the connection potions, in a rear end from the sheath outer tube.

### BRIEF DESCRIPTION OF THE DRAWINGS

FIG. 1 is a sectional structure view in which a temperature sensor according to a first embodiment of the present invention is cut along an axis direction.

FIG. 2 is an enlarged view of the distal end part of the temperature sensor of FIG. 1.

FIG. 3 is an enlarged view of the rear end part of the temperature sensor of FIG. 1.

FIG. 4 is a schematic sectional diagram showing another mode of an insulation covering portion.

FIG. 5 is a sectional structure view in which a temperature sensor according to a second embodiment of the present invention is cut along an axis direction.

FIG. 6 is an enlarged view of the distal end part of the temperature sensor of FIG. 5.

FIG. 7 is an enlarged view of the rear end part of the temperature sensor of FIG. 5.

FIG. 8 is a schematic sectional diagram showing one mode of a sheet-like insulation covering portion.

FIG. 9 is a schematic sectional diagram showing another mode of the sheet-like insulation covering portion.

FIG. 10 is a schematic sectional diagram showing further another mode of the sheet-like insulation covering portion.

### DETAILED DESCRIPTION

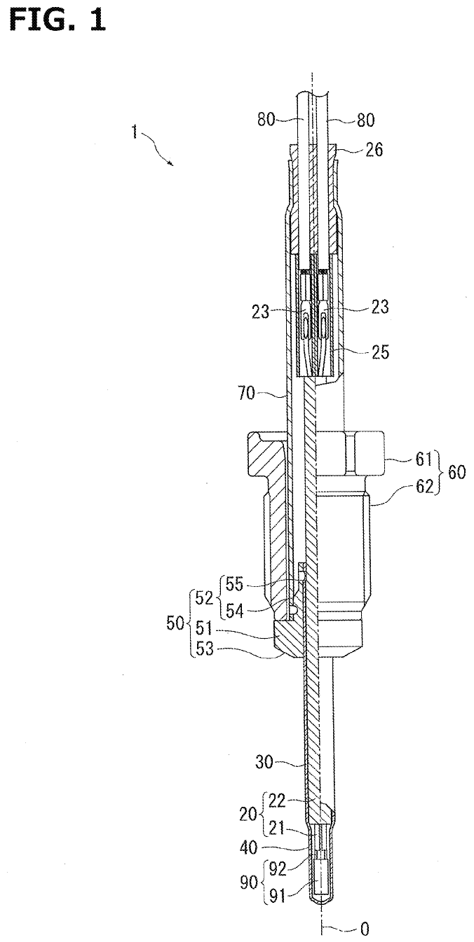

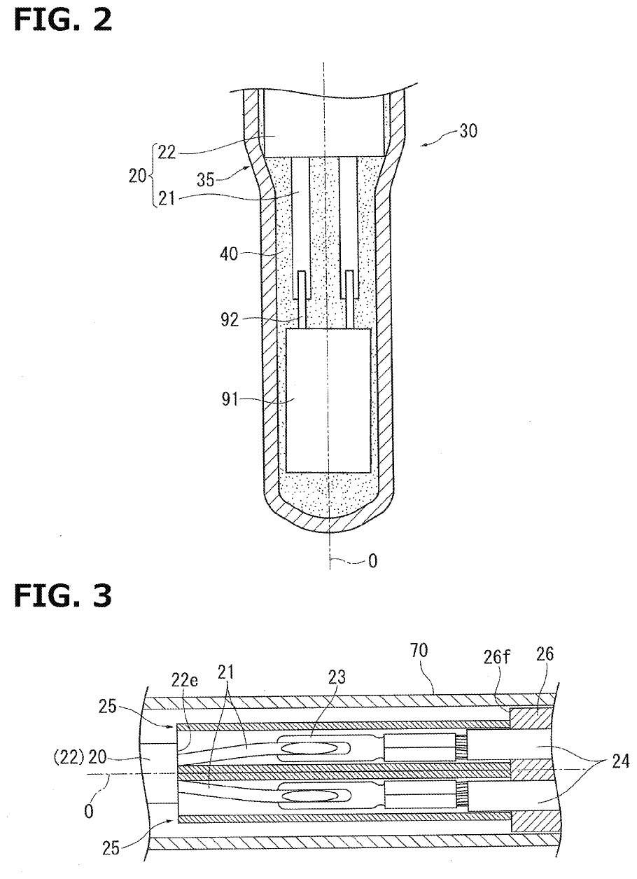

In the following, an embodiment of the present invention will be explained. FIG. 1 is a sectional structure view in which a temperature sensor 1 according to a first embodiment of the present invention is cut along the direction of an axis O. FIG. 2 is an enlarged view of the distal end part of the temperature sensor 1 of FIG. 1. FIG. 3 is an enlarged view of the rear end part of the temperature sensor 1 of FIG. 1. In addition, in the temperature sensor 1 according to the first embodiment, temperature is measured by the after-mentioned temperature sensitive element 90, and a sheath member 20 is accommodated from the rear end side of a metal protective tube 30. The temperature sensor 1 is attached by being inserted into an opening portion (not shown in the drawings) of a side wall of an exhaust pipe in an internal combustion engine, and detects a temperature of exhaust gas of a vehicle. Then, when the temperature of the exhaust gas rapidly changes from a low temperature of about 0° C. to a high temperature of about 1000° C., with this temperature change, the temperature sensor 1 is exposed to this temperature.

The temperature sensor 1 is provided with a Pt-resistor element (temperature sensitive element) 90, the sheath member 20 connected to the Pt-resistor element 90, the after-mentioned tube-like insulation covering portions 25, the cylindrical protective tube 30 having a bottom which accommodates the Pt-resistor element 90 and the sheath member 20, an attachment portion 50 fitted to the outer periphery of the protective tube 30, a nut portion 60 loosely fitted to the outer periphery of the attachment portion 50, a cylindrical metal outer cylinder 70 attached to the rear end side of the attachment portion 50, and with an auxiliary ring 26 made of heat-resistant rubber which is attached to the rear end of the outer cylinder 70 and is provided to pull out lead wires 80 to the outside. In addition, in the temperature sensor 1 of the present invention, the protective tube 30 extends in the axis O direction, and the bottom side of the protective tube 30 is defined as a “distal end”, and the opening end side of the protective tube 30 is defined as a “rear end”. The outer cylinder 70 corresponds to a “second protective tube” of the scope of the claims.

The Pt-resistor element (temperature sensitive element) 90 includes a Pt-resistor portion (temperature sensitive portion) 91 for measuring temperature and a pair of element electrode wires 92 extending from one end (rear end side) of the Pt-resistor portion 91. The Pt-resistor portion 91 is configured by sandwiching a metal resistor having a film shape with ceramic layers, and has a substantially plate shape as a whole. The Pt-resistor portion 91 is disposed inside the protective tube 30 such that the longitudinal direction thereof becomes parallel to the axis O direction of the temperature sensor 1 (protective tube 30). The metal resistor has a composition of platinum (Pt) as a main component (50 mass % or greater), and the pair of the element electrode wires 92 are separately connected to the metal resistor. Then, since the electric resistance value of the metal resistor is changed in accordance with a change in temperature, it is possible to detect the change as a voltage change between the pair of the element electrode wires 92. As the ceramic layers, a composition in which an alumina purity is 99.9 mass % or greater can be used. In addition, as the temperature sensitive portion, a thermistor can be also used in addition to such a Pt-resistor.

The sheath member 20 includes sheath core wires 21 connected to the pair of the respective element electrode wires 92 of the Pt-resistor element 90, and a metal sheath outer tube 22 accommodating the sheath core wires 21. An insulation material constituted of SiO₂ is filled between the sheath core wires 21 and the inner surface of the sheath outer tube 22. In general, since the element electrode wires 92 are each formed by, for example, an expensive Pt—Rh wire, by being connected to the inexpensive sheath core wires 21 made of, for example, SUS, cost reduction is achieved.

In the present embodiment, the protective tube 30 is made of SUS310S, and straightly extends parallel to the axis O direction, and the distal end of the protective tube 30 is closed. In addition, the protective tube 30 includes a tapered portion 35 whose diameter is enlarged toward the rear end side, and the rear end side of the protective tube 30 from the tapered portion 35 extends straight. The inner diameter of the protective tube 30 more on the distal end side than the tapered portion 35 is smaller than the outer diameter of the sheath outer tube 22 of the sheath member 20, and is larger than the maximum outer diameter of the Pt-resistor portion 91. On the other hand, the inner diameter of the protective tube 30 more on the rear end side than the tapered portion 35 is larger than the outer diameter of the sheath outer tube 22 of the sheath member 20. With this, when the sheath member 20 and the Pt-resistor element 90 are inserted from the rear end side of the protective tube 30, the distal end side of the sheath member 20 comes in contact with the tapered portion 35, and insertion depth is positioned. Consequently, the distal end side of the sheath member 20 closes an opening portion of the protective tube 30, and at least the Pt-resistor element 90 and the distal end side of the sheath member 20 are accommodated in the internal space of the protective tube 30. In addition, the internal space is filled with a cement 40.

The attachment portion 50 is formed in a substantially cylindrical shape, and has a central hole into which the protective tube 30 is inserted and which opens in the axis O direction. The attachment portion 50 is formed with a flange portion 51 having a large diameter, a cylindrical sheath portion 52 having a diameter smaller than that of the flange portion 51, a first step portion 54 forming the distal end side of the sheath portion 52, and a second step portion 55 which forms the rear end side of the sheath portion 52 and has a diameter smaller than that of the first step portion 54, in this order from the distal end side of the temperature sensor 1. The flange portion 51 includes a seat surface 53 having a tapered shape on the distal end surface thereof, and when the after-mentioned nut portion 60 is screwed to the exhaust pipe, the seat surface 53 is pressed to a corner (not shown in the drawings) of a side wall of the exhaust pipe to carrying out sealing. The attachment portion 50 is press-fitted to the outer periphery of the rear end portion of the protective tube 30, and, to fix them to each other, the second step portion 55 and the protective tube 30 are fixed by whole circumference laser welding. In addition, the outer cylinder 70 is press-fitted to the outer periphery of the first step portion 54, and then they are fixed to each other by whole circumference laser welding. The outer cylinder 70 accommodates and holds connection portions (crimp terminals 23) of the lead wires 80 and the sheath core wires 21 pulled out from the sheath member 20.

The nut portion 60 includes a central hole in the axis O direction which has a diameter slightly larger than the outer periphery of the outer cylinder 70, and is formed with, from the distal end side, a screw portion 62 and a hexagonal nut portion 61 having a diameter slightly larger than that of the screw portion 62. Then, in a state in which the front surface of the screw portion 62 is brought into contact with the rear surface of the flange portion 51 of the attachment portion 50, the nut portion 60 is loosely fitted to the outer periphery of the attachment portion 50 (outer cylinder 70), thereby being freely rotatable in the axis O direction. Then, the screw portion 62 is screwed with a predetermined screw hole of the exhaust pipe, and the temperature sensor 1 is attached to a side wall of the exhaust pipe.

The two sheath core wires 21 are pulled out from the rear end of the sheath outer tube 22 of the sheath member 20, and the terminal ends of the sheath core wires 21 are connected to the respective distal ends of a pair of the crimp terminals 23 by welding. The terminal ends of the crimp terminals 23 are crimped and connected to the respective lead wires 80. The crimp terminals 23 correspond to “connection terminals” of the scope of the claims. In addition, the sheath core wires 21 and corresponding ones of the crimp terminals 23 are insulated by the respective insulation covering portions 25.

Then, each of the lead wires 80 is pulled out to the outside through a corresponding one of insertion holes of the heat-resistant rubber grommet 26 fitted to the inside on the rear end side of the outer cylinder 70, and is connected to an electronic controller unit (ECU) of a vehicle through an external circuit which is not shown in the drawings. In addition, the cement 40, such as alumina, is filled to the space between the inner surface of the protective tube 30 and the Pt-resistor element 90 and the sheath member 20, thereby, by holding the Pt-resistor element 90 and the sheath member 20, suppressing their vibration. As the cement 40, a material having high thermal conductivity, high heat resistance properties, and high insulation properties may be used.

Next, with reference to FIG. 3, a configuration including the insulation covering portions 25 that are characteristic parts of the present invention will be explained. In the rear end from the sheath outer tube 22, the insulation covering portions 25 individually cover and insulate the respective crimp terminals 23 that are a pair of connection portions connecting the sheath core wires 21 with the respective lead wires 24, and are formed of glass braids. Here, in an example of FIG. 3, a pair of the insulation covering portions 25 are provided, and the insulation covering portions 25 insulate the respective crimp terminals 23 individually so as to surround them. The glass braid has a form in which glass fibers are woven, and as a glass, a composition containing oxide of at least one element selected from the group consisting of, for example, Si, Ca, Al and Mg can be sited.

In this way, since the connection portions (crimp terminals 23) which are provided to the inside of the temperature sensor 1, and which connect the sheath core wires 21 that are wirings from the temperature sensitive element 90 and the respective lead wires 24 are individually covered with the respective insulation covering portions 25 formed of glass braids and having a high heat resistance, it is possible to surely insulate the connection portions even under a high temperature condition. Consequently, it is possible to suppress the deterioration of the accuracy of the temperature measuring and suppress to become unable to measure temperature due to the occurrence of the short circuit between the lead wires 24.

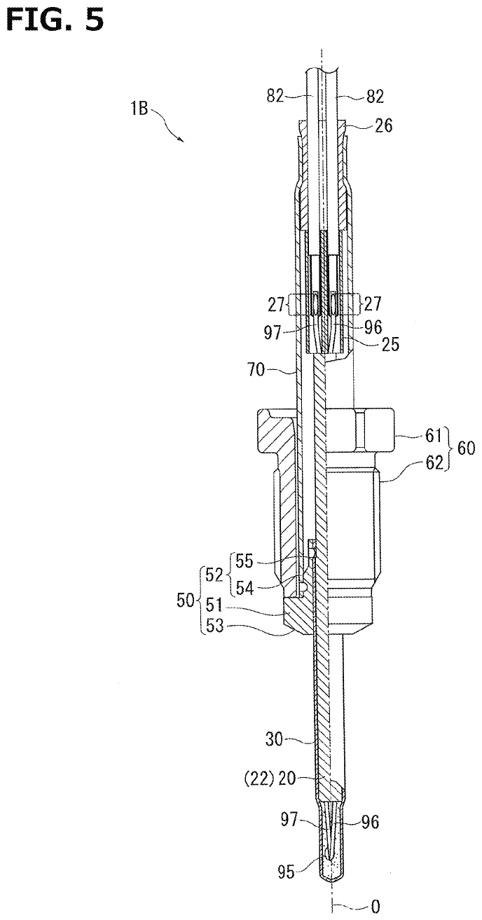

In addition, in an example of FIG. 3, each of the insulation covering portions 25 extends between a rear end 22e of the sheath outer tube 22 and a distal end 26f of the grommet 26. Moreover, each of the distal ends of the insulation covering portions of the leads wires 24 protrudes to the distal end from the distal end 26f of the grommet 26. Consequently, the insulation covering portions 25 completely cover the crimp terminals 23 in the axis O direction. Since the crimp portions 23 are thick and heavy as compared with the sheath core wires 21 and the lead wires 24, they move and come in contact with each other (shirt circuit) easily when the temperature sensor 1 vibrates due to, for example, the traveling of the vehicle. It is therefore preferable to completely cover the crimp terminals 23 with the respective insulation covering portions 25 in the axis O direction. With this, even under a vibration condition, the connection portions can be further surely insulated. On the other hand, although the details will be explained below, like a temperature sensor 1B shown in each of FIG. 5 to FIG. 7, in a case where connection portions are directly formed without using another member, such as a crimp portion, it is not necessary to completely cover the connection portions with the insulation covering portions 25 in the axis O direction.

If a weight change of each of the insulation covering portions 25 at 25-600° C. is 0.5% or less, the heat resistance property of the insulation covering portions 25 becomes high, and the connection portions can be further surely insulated under a high temperature condition. In addition, in an example of FIG. 3, the outer cylinder 70 accommodates the insulation covering portions 25 in a non-contact state. Consequently, it is possible to protect the insulation covering portions 25 from the outside while securing the insulation of the insulation covering portions 25.

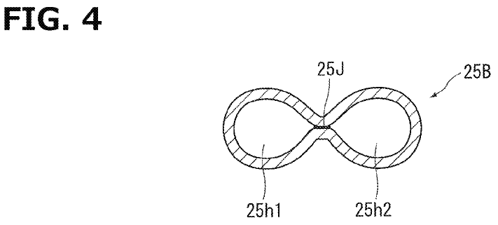

In addition, a pair of insulation covering portions may not be used. Instead of these, as shown in FIG. 4, one cylindrical insulation covering portion 25B may be used, and in the insulation covering portion 25B, a connection portion 25J is formed by joining an inner surface facing each other of the insulation covering portion 25B in one location, and two cylindrical portions 25h1 and 25h2 sandwiching the connection portion 25J therebetween is formed. In this case, the pair of the crimp terminals 23 are individually accommodated in the respective cylindrical portions 25h1 and 25h2.

In addition, it is preferable that a coating layer made of glass is formed on the surface of the glass-braided body of each of the insulation covering portions 25. By glass-coating the surface of the glass-braided tube of each of the insulation covering portions 25, the glass braid is hardly loosened, and manufacturing stability and insulation stability at the time of use are improved. In addition, the glass braid is flexible, and as compared with an insulation material made of ceramic or glass alone, it is hard to break, and is resistant to impact of, for example, flying rocks. Moreover, as compared with another inorganic braided body, the glass-braided body is superior in insulation properties under a high temperature environment. Here, the glass coating layer can be obtained by adding a raw material to the glass-braided body with a well-known method, and conducting heat treatment to it.

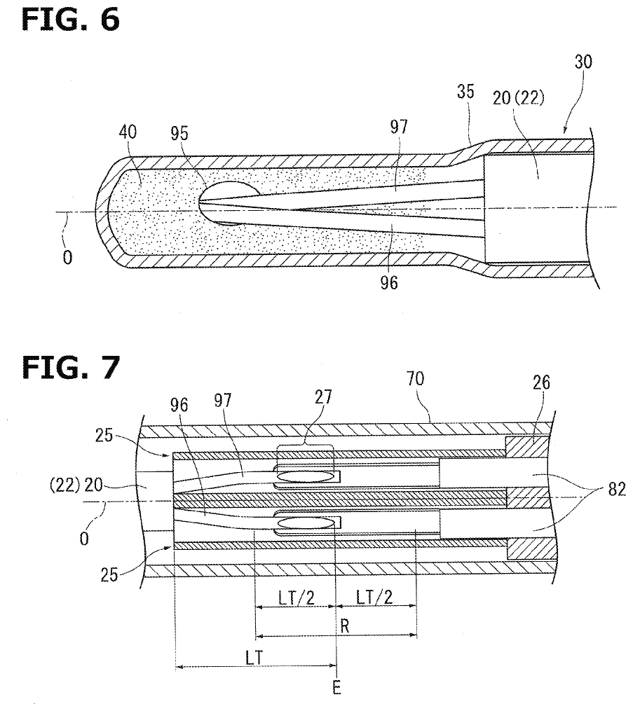

Next, with reference to FIG. 5 and FIG. 6, the temperature sensor 1B according to a second embodiment of the present invention will be explained. FIG. 5 is a sectional structure view in which the temperature sensor 1B according to the second embodiment of the present invention is cut along an axis O direction. FIG. 6 is an enlarged view of the distal end part of the temperature sensor 1B of FIG. 5. FIG. 7 is an enlarged view of the rear end part of the temperature sensor 1B of FIG. 5. Here, in the temperature sensor 1B according to the second embodiment, temperature is measured by the after-mentioned temperature measuring junction 95 of a thermocouple, and a sheath member 20 is accommodated from the rear end side of a metal protective tube 30. In addition, in the temperature sensor 1B, in the same components as the temperature sensor 1 according to the first embodiment, the same symbols are applied to the same components, and redundant explanation is omitted. The temperature sensor 1B is also attached by being inserted into an opening portion (not shown in the drawings) of a side wall of an exhaust pipe in an internal combustion engine, and detects a temperature of exhaust gas of a vehicle.

The temperature sensor 1B is provided with a pair of thermocouple wires 96 and 97, a temperature measuring junction 95, a sheath outer tube 20, a cylindrical protective tube 30 having a bottom, a cement holding agent 40 dispose inside the protective tube 30, an attachment portion 50 fitted to the outer periphery of the protective tube 30, a nut portion 60 loosely fitted to the outer periphery of the attachment portion 50, a cylindrical metal outer cylinder 70 attached to the rear end side of the attachment portion 50, and with a grommet 26 made of heat-resistant rubber which is attached to the rear end of the outer cylinder 70 and is provided to pull out compensation conductive wires 82 to the outside.

The thermocouple wires 96 and 97 are made of different materials from each other. In the present embodiment, one thermocouple wire 96 is made of an alloy containing nickel, chromium and silicon, and the other thermocouple wire 97 is made of an alloy containing nickel and silicon. Then, the distal ends of the respective thermocouple wires 96 and 97 are joined to each other by, for example, welding, and the temperature measuring junction 95 is formed.

The thermocouple wires 96 and 97 are each inserted into the inside of a sheath outer tube 22, and sheath outer tube 22 covers a part other than both ends of each of the thermocouple wires 96 and 97. The space between the sheath outer tube 20 and each of the thermocouple wires 96 and 97 is filled with insulation material constituted of, for example, SiO₂. Accordingly, in a state in which the sheath outer tube 22 is electrically insulated from each of the thermocouple wires 96 and 97, each of the thermocouple wires 96 and 97 is held inside the sheath outer tube 22. In addition, in the temperature sensor 1B, the sheath core wires 21 are not used, and the sheath outer tube 22 is the same as the sheath member 20.

Further, each of the thermocouple wires 96 and 97 is pulled out from the rear end of the sheath outer tube 22, and the terminal end of each of the thermocouple wires 96 and 97 is directly connected to a corresponding one of the compensation conductive wires 82 by welding. The compensation conductive wires 82 are pulled out to the outside by passing through respective insertion holes of the grommet 26 fitted to the inner side of the rear end of the outer cylinder 70, and are each connected to an ECU through an external circuit which is not shown in the drawings. Here, welding parts in which the thermocouple wires 96 and 97 are electrically connected to the respective compensation conductive wires 82 form connecting portions 27. In addition, the thermocouple wires 96 and 97 are insulated by respective insulation covering portions 25.

Also in the temperature sensor 1B according to the second embodiment of the present invention, since the connection portions 27 between the thermocouple wires 96 and 97 from the temperature measuring junction 95 and the respective compensation conductive wires 82, the connection portions 27 which are provided to the inside of the temperature sensor 1B, are individually covered with the respective insulation covering portions 25 formed of glass braids and having a high heat resistance, it is possible to surely insulate the connection portions even under a high temperature condition.

Here, as shown in FIG. 7, it is preferable that each of the insulation covering portions 25 covers at least a region R that is the sum of a length extending to the distal side and a length extending to the rear side from a rear end E in the axis O direction of each of the thermocouple wires 96 and 97, each of which corresponds to 50% of TL that is a length TL in the axis O direction of each of the thermocouple wires 96 and 97 exposed from the rear end of the sheath outer tube 22. In a case where the thermocouple wires 96 and 97 are directly connected to the respective compensation conductive wires 82 without using terminals, such as crimp terminals, since these thermocouple wires 96 and 97 and the compensation conductive wires 82 are light as compared with the terminals, they are hard to move even if the temperature sensor 1B vibrates. It is therefore not necessary to completely cover the exposed thermocouple wires 96 and 97 and compensation conductive wires 82 in the axis O direction with the insulation covering portions 25. However, the region R is located between the thermocouple wires 96 and 97 and the fixed ends of the compensation conductive wires 82 with the connection portions 27 therebetween (between the exposed part on the distal end side of each of the thermocouple wires 96 and 97 and the exposed part on the rear end side of each of the compensation conductive wires 82 in FIG. 7), and they are easily move by the vibration. Therefore, by covering at least the region R with the insulation covering portions 25, the insulation of the connection portions can be further surely carried out even under a vibration condition.

In addition, the exposed thermocouple wires 96 and 97 and compensation conductive wires 82 may be completely covered in the axis O direction with the insulation covering portions 25. Here, in a case where the rear end positions in the axis O direction of the thermocouple wires 96 and 97 are different from each other, as the rear end E, the distal end side of the rear ends of the thermocouple wires 96 and 97 is adopted, because, in the present embodiment, the compensation conductive wires 82 are firmly fixed by the grommet 26 and the compensation conductive wires 82 are thicker than the thermocouple wires 96 and 97, and the rear end side is hard to move, and the distal end side relatively easily moves.

The present invention is not limited to the above embodiments, and it is needless to say that the present invention includes various changes and equivalents within the scope of the present invention. For example, as a temperature sensitive portion, a thermistor sintered body may be used instead of the above-mentioned Pt-resistor portion 91. As a thermistor sintered body, perovskite type oxide having a base composition of (Sr, Y) (Al, Mn, Fe) O₃ can be used. However, it is not limited to this. In addition, a connection portion between a sheath core wire and a lead wire is not limited to a mode using another member, such as the above-mentioned connection terminals, and may be a mode in which, for example, a sheath core wire and a lead wire are directly superposed on each other and then welded. On the other hand, a connection portion between a thermocouple wire and a compensation wire may be a mode using another member, such as the above-mentioned connection terminals.

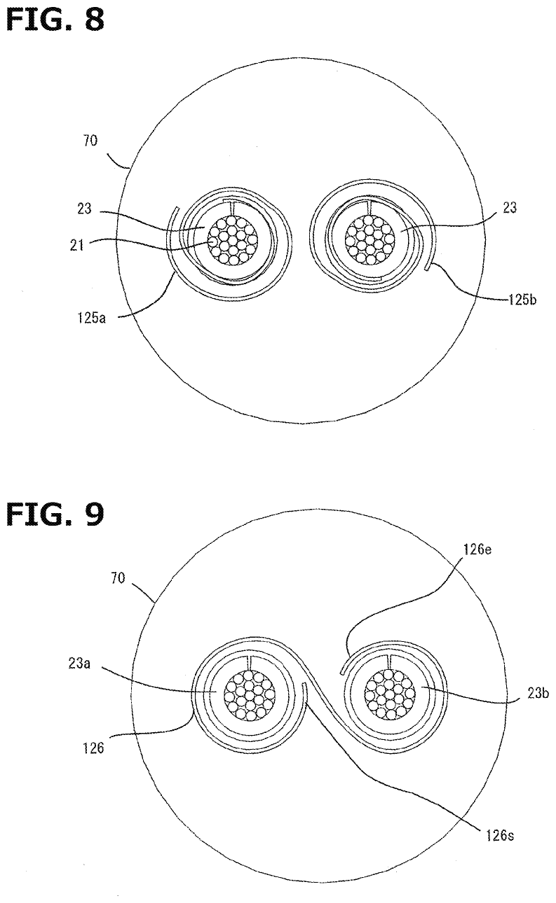

The shape of an insulation coating portion is not limited to a tube shape, and may be a sheet shape. For example, as shown in FIG. 8, a mode in which two sheet-like insulation covering portions 125a and 125b are wound around the respective connection portions (crimp terminals 23) of the temperature sensor 1 of FIG. 1 may be used. In addition, as shown in FIG. 9, a mode in which one sheet-like insulation covering portion 126 is wound around connection portions (crimp portions) may be used. In an example of FIG. 9, the insulation covering portion 126 is wound in a shape of 8 in such a manner that, after one end 126s side of the insulation covering portion 126 is wound around one connection portion 23a (left side in FIG. 9) clockwise, the insulation covering portion 126 extends toward the other connection portion 23b (right side in FIG. 9) across the both connection portions 23a and 23b, and is wound around the connection portion 23b counterclockwise such that the other end 126e of the insulation covering portion 126 is positioned on the connection portion 23b side.

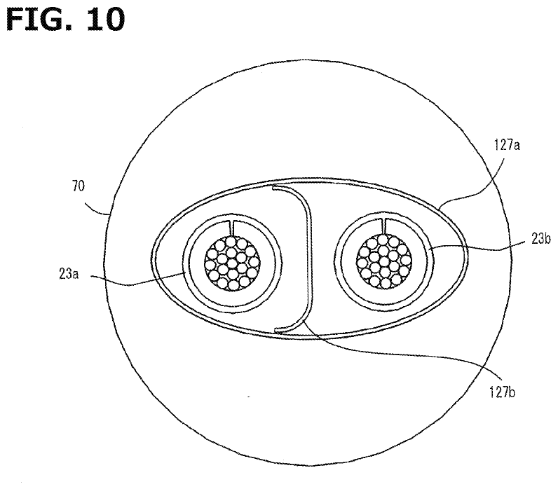

Moreover, as shown in FIG. 10, a mode using, in addition to one tube-like (or sheet-like) insulation covering portion 127a, an insulation covering portion 127b serving as a partition material may be used. In an example of FIG. 10, the insulation covering portion 127a covers around the connection portions 23a and 23b, and the insulation covering portion 127b is disposed between the connection portions 23a and 23b, and thereby the insulation between the connection portions 23a and 23b is carried out. In addition, to prevent careless movement of the insulation covering portion 127b inside the insulation covering portion 127a, the length in the cross-sectional direction (direction crossing the axis O) of the insulation covering portion 127b is set so as to be longer than the inner diameter of the insulation covering portion 127a in the direction in which the insulation covering portion 127b extends, and, as shown in FIG. 10, both of the ends of the insulation covering portion 127b are bent and then engage with the inner surface of the insulation covering portion 127a.

In the above embodiments, although the protective tube 30 covers the sheath outer tube 22 toward the outer cylinder 70, like a sensor described in each of Japanese Patent Application Publication No. 2018-036188 and Japanese Patent Application Publication No. 2016-197095, a mode may be used in which the protective tube 30 has a length to cover only the vicinity of the temperature measuring junction 95 in order to only cover the distal end portion of an intermediate outer cylinder different from the outer cylinder 70, and this intermediate outer cylinder covers the thermocouple wires 96 and 97 extending on the rear end side of the temperature measuring junction 95 and extends to the outer cylinder 70.

The following summarizes features of the present embodiments.

A temperature sensor (1) according to a first embodiment includes: a temperature sensitive element (90); a sheath member (20) which is provided on a rear end side of the temperature sensitive element (90), and which includes a pair of sheath core wires (21) connected to the temperature sensitive element (90), and a sheath outer tube (22) accommodating the sheath core wires (21) inside an insulation material; a pair of lead wires (80) which are disposed on a rear end side of the sheath member (20), and which are directly or indirectly connected to the respective sheath core wires (21) exposed more on a rear end side than the sheath outer tube (22); and glass-braided insulation covering portions (25, 25B, 125a, 125b, 126, 127a, 127b) individually covering a pair of respective connection portions (23) of the sheath core wires (21) and the lead wires (80), so as to insulate between the pair of the connection potions (23), in a rear end from the sheath outer tube (22). According to this temperature sensor (1), since the connection portions (23) of the sheath core wires (21) that are wires from the temperature sensitive element (90) and the lead wires (80), the connection portions which are disposed inside the temperature sensor (1), are individually covered with the respective insulation covering portions (25, 25B, 125a, 125b, 126, 127a, 127b) each formed of the glass braid and having high heat resistance properties, the connection portions (23) can be surely insulated even under a high temperature condition. Consequently, it is possible to suppress the deterioration of the accuracy of the temperature measuring and suppress to become unable to measure temperature due to the occurrence of the short circuit between the lead wires (80). In addition, since the glass braid is flexible, and as compared with an insulation material made of ceramic or glass alone, it is hard to break, and is resistant to impact of, for example, flying rocks. Moreover, each of the insulation covering portions (25, 25B, 125a, 125b, 126, 127a, 127b) may has a tube shape, or a mode in which sheet-like insulation portions are wound around the connection portions (23) may be used. Further, if the insulation between the pair of the connection portions (23) is secured, each of the connection portions (23) may be partially covered.

A temperature sensor (1B) according to a second embodiment includes: a pair of thermocouple wires (96, 97); a temperature measuring junction (95) formed by joining distal ends of the pair of the thermocouple wires (96, 97) to each other; a sheath member (20) including at least a sheath outer tube (22) for projecting the thermocouple wires (96, 97) from a distal end and a rear end thereof, while accommodating the thermocouple wires (96, 97) inside an insulation material; a pair of compensation conductive wires (82) which are disposed on a rear end side of the sheath outer tube (22), and which are directly or indirectly connected to the respective thermocouple wires (96, 97) exposed more on a rear end side than the sheath outer tube (22); and glass-braided insulation covering portions (25, 25B, 125a, 125b, 126, 127a, 127b) individually covering a pair of respective connection portions (27) of the thermocouple wires (96, 97) and the compensation wires (82), so as to insulate between the pair of the connection potions (27), in a rear end from the sheath outer tube (22). According to this temperature sensor (1B), since the connection portions (27) of the thermocouple wires (96, 97) that are wires from the temperature measuring junction (95) and the compensation wires (82), the connection portions which are disposed inside the temperature sensor (1B), are individually covered with the respective insulation covering portions (25, 25B, 125a, 125b, 126, 127a, 127b) each formed of the glass braid and having high heat resistance properties, the connection portions (27) can be surely insulated even under a high temperature condition. In addition, since the glass braid is flexible, and as compared with an insulation material made of ceramic or glass alone, it is hard to break, and is resistant to impact of, for example, flying rocks. Moreover, each of the insulation covering portions (25, 25B, 125a, 125b, 126, 127a, 127b) may has a tube shape, or a mode in which sheet-like insulation portions are wound around the connection portions (27) may be used. Further, if the insulation between the pair of the connection portions (27) is secured, each of the connection portions (27) may be partially covered.

In the temperature sensor (1, 1B), the insulation covering portions (25, 25B, 125a, 125b, 126, 127a, 127b) may each have a tube shape. According to the temperature sensor (1, 1B), since each of the insulation covering portions (25, 25B, 125a, 125b, 126, 127a, 127b) has a tube shape, it is superior in mechanical strength, and the insulation is further surely secured.

In the temperature sensor (1, 1B), a weight change of each of the insulation covering portions (25, 25B, 125a, 125b, 126, 127a, 127b) at 25-600° C. may be 0.5% or less. According to the temperature sensor (1, 1B), heat resistance properties of the insulation covering portions (25, 25B, 125a, 125b, 126, 127a, 127b) become high, and the connection portions (23, 27) can be further surely insulated under a high temperature condition.

In the temperature sensor (1, 1B), the temperature sensor (1, 1B) may further include a protective tube (30) of which a distal end side is closed, which extends in an axis (O) direction, and which accommodates at least the temperature sensitive element (90) or the temperature measuring junction (95) and a distal end side of the sheath member (20). According to the temperature sensor (1, 1B), the temperature sensitive element (90) or the temperature measuring junction (95) can be surely accommodated and protected.

In the temperature sensor (1), the sheath core wires (21) are electrically connected with the respective lead wires (80) through respective connection terminals (23), so that the connection portions (23) are formed, and the insulation covering portions (25, 25B, 125a, 125b, 126, 127a, 127b) may cover at least the respective connection terminals (23). Since the connection terminals (23) are thick and heavy as compared with the sheath core wires (21) and the lead wires (80), they move and come in contact with each other (shirt circuit) easily when the temperature sensor (1) vibrates due to, for example, the traveling of the vehicle. Therefore, by covering the connection terminals (23) with the respective insulation covering portions (25, 25B, 125a, 125b, 126, 127a, 127b), even under a vibration condition, the connection portions (23) can be further surely insulated.

In the temperature sensor (1B), the thermocouple wires (96, 97) are electrically connected with the respective compensation conductive wires (82) through respective connection terminals (23), so that the connection portions (27) are formed, and the insulation covering portions (25, 25B, 125a, 125b, 126, 127a, 127b) cover at least the respective connection terminals (23). Since the connection terminals (23) are thick and heavy as compared with the thermocouple wires (96, 97) and the compensation conductive wires (82), they move and come in contact with each other (shirt circuit) easily when the temperature sensor (1B) vibrates due to, for example, the traveling of the vehicle. Therefore, by covering the connection terminals (23) with the respective insulation covering portions (25, 25B, 125a, 125b, 126, 127a, 127b), even under a vibration condition, the connection portions (23) can be further surely insulated.

In the temperature sensor (1, 1B), the temperature sensor (1, 1B) may further include a second protective tube (70) which accommodates the insulation covering portions (25, 25B, 125a, 125b, 126, 127a, 127b) in at least a non-contact state. According to the temperature sensor (1, 1B), the insulation covering portions (25, 25B, 125a, 125b, 126, 127a, 127b) can be protected from the outside while securing the insulation of the insulation covering portions (25, 25B, 125a, 125b, 126, 127a, 127b).

In the temperature sensor (1, 1B), a glass coating layer is formed on a surface of a glass-braided body of each of the insulation covering portions (25, 25B, 125a, 125b, 126, 127a, 127b). According to the temperature sensor (1, 1B), glass coating is subjected to the surface of the glass-braided tube of each of the insulation covering portions (25, 25B, 125a, 125b, 126, 127a, 127b), and consequently, the glass braid is hardly loosened, and manufacturing stability and insulation stability at the time of use are improved.

The entire contents of Japanese Patent Application 2018-151551 filed Aug. 10, 2018 and Japanese Patent Application 2019-078775 filed Apr. 17, 2019 are incorporated herein by reference.

1. A temperature sensor comprising:
a temperature sensitive element;
a sheath member which is provided on a rear end side of the temperature sensitive element, and which includes a pair of sheath core wires connected to the temperature sensitive element, and a sheath outer tube accommodating the sheath core wires inside an insulation material;
a pair of lead wires which are disposed on a rear end side of the sheath member, and which are directly or indirectly connected to the respective sheath core wires exposed more on a rear end side than the sheath outer tube; and
glass-braided insulation covering portions individually covering a pair of respective connection portions of the sheath core wires and the lead wires, so as to insulate between the pair of the connection potions, in a rear end from the sheath outer tube.

2. The temperature sensor according to claim 1, wherein the insulation covering portions each have a tube shape.

3. The temperature sensor according to claim 1, wherein a weight change of each of the insulation covering portions at 25-600° C. is 0.5% or less.

4. The temperature sensor according to claim 1, further comprising a protective tube of which a distal end side is closed, which extends in an axis direction, and which accommodates at least the temperature sensitive element and a distal end side of the sheath member.

5. The temperature sensor according to claim 1, wherein the sheath core wires are electrically connected with the respective lead wires through respective connection terminals, so that the connection portions are formed, and
wherein the insulation covering portions cover at least the respective connection terminals.

6. The temperature sensor according to claim 1, further comprising a second protective tube which accommodates the insulation covering portions in at least a non-contact state.

7. The temperature sensor according to claim 1, wherein a glass coating layer is formed on a surface of a glass-braided body of each of the insulation covering portions.

8. A temperature sensor comprising:
a pair of thermocouple wires;
a temperature measuring junction formed by joining distal ends of the pair of the thermocouple wires to each other;
a sheath member including at least a sheath outer tube for projecting the thermocouple wires from a distal end and a rear end thereof, while accommodating the thermocouple wires inside an insulation material;
a pair of compensation conductive wires which are disposed on a rear end side of the sheath outer tube, and which are directly or indirectly connected to the respective thermocouple wires exposed more on a rear end side than the sheath outer tube; and
glass-braided insulation covering portions individually covering a pair of respective connection portions of the thermocouple wires and the compensation wires, so as to insulate between the pair of the connection potions, in a rear end from the sheath outer tube.

9. The temperature sensor according to claim 8, wherein the insulation covering portions each have a tube shape.

10. The temperature sensor according to claim 8, wherein a weight change of each of the insulation covering portions at 25-600° C. is 0.5% or less.

11. The temperature sensor according to claim 8, further comprising a protective tube of which a distal end side is closed, which extends in an axis direction, and which accommodates at least the temperature measuring junction and a distal end side of the sheath member.

12. The temperature sensor according to claim 8, wherein the thermocouple wires are electrically connected with the respective compensation conductive wires through respective connection terminals, so that the connection portions are formed, and
wherein the insulation covering portions cover at least the respective connection terminals.

13. The temperature sensor according to claim 8, further comprising a second protective tube which accommodates the insulation covering portions in at least a non-contact state.

14. The temperature sensor according to claim 8, wherein a glass coating layer is formed on a surface of a glass-braided body of each of the insulation covering portions.
